(19) United States
(12) Patent Application Publication
(10) Pub. No.: US 2009/0190297 A1
(43) Pub. Date: Jul. 30, 2009

(54) Motherboard expansion device

(76) Inventors: Michael Feldman, Thornhill (CA); Alexander Feldman, Maple (CA); Boris Feldman, Thornhill (CA)

Correspondence Address: FELDMAN MICHAEL, 148 CARL TENNEN ST., THORNHILL, ON, L4J7B1, CA

(21) Appl. No.: 12/011,646

(22) Filed: Jan. 29, 2008

(51) Int. Cl. G06F 1/16

(52) U.S. Cl. 361/679.32; 361/796

(57) ABSTRACT

The invention is to provide a motherboard expansion device that expands the possibility to use non-portable computers in different applied systems and allows them to operate with a plurality of external devices.

### CROSS-REFERENCE TO RELATED APPLICATION

This is the first application filed for the present invention.

### TECHNICAL FIELD

The present invention relates to the computer motherboard expansion systems and, in particular, to the means that extend functionality and performance of the multi-channel and multi-function input/output computer systems by using a special device that would be placed into the expansion bay inside a computer chassis.

### BACKGROUND OF THE INVENTION

Today modern personal computers are widely used as a control part of different applied systems that incorporates a plurality of peripheral devices. These peripheral devices are connected to corresponding external plugs/sockets that are mounted on separate interface boards (cards) that are connected to the motherboard by corresponding high-speed interface connectors.

The space that may be used for mounting interface connectors for connection to said peripheral devices is bounded by corresponding specifications and standards.

The total amount of connected devices is defined by the quantity of said interface boards (cards) that can be connected to the motherboard simultaneously (quantity of sockets on the motherboard) and by the quantity of external interface connectors that it is possible to mount on said boards (cards) based on corresponding specification for said card.

The development road map of modern personal computers (motherboards) demonstrates a direction to reduce the quantity of sockets for connection to various interfaces boards (cards) and at the same time to increase the bandwidth of each socket (by using higher speed interface for connection between said interface board (card) and motherboard) placed on the motherboard.

Five years ago the most popular motherboards had five 32-bit PCI sockets(slots), allowing to connect up to five interface boards (cards), and today the modern motherboards usually have only four sockets: one x16 PCI express connector, two 32-bits PCI connectors and one x1 PCI express connector. The total bandwidth of the above mentioned sockets is equivalent to the bandwidth of nineteen 32-bit PCI connectors. Correspondingly, the bandwidth has increased significantly, but the quantity of mountable interface boards has been reduced.

On the other hand, the plurality of the different peripheral devices and their increasing complexity is forcing designers to use additional dedicated equipment (expansion units and special purpose processors) to increase main computer performance by unloading the main processor on the motherboard. A plurality of powerful specialized chips for data processing (like FPGA, DSP etc) is available on the market, and they can be used for data processing in case of multiple data channels and multiple peripheral devices.

So, as we can see the direction of developing new computers is bounded by the disbalance between bandwidth of the interfaces on the motherboard for plug-in interface boards (cards), availability of powerful specialized chips for data processing and low bandwidth (external bandwidth) of the external interface connectors on the interface boards (cards).

A number of patents that are connected with this problem are known.

In U.S. Pat. No. 5,666,267 authors Carter; Bill W. et al. propose an audio I/O extension card having a first audio I/O connector disposed at an inner edge of the audio I/O extension card for exchanging audio I/O signals with a conventional back portion, embedded circuitry for routing the audio I/O signals from the inner edge to the outer edge of the audio I/O extension card, a plurality of audio ports disposed at the outer edge of the audio I/O extension card for exchanging the audio I/O signals with external audio devices, and said audio I/O extension card being shaped and dimensioned to coexist with a hard drive in a hard drive bay without intruding into a conventional space of the hard drive bay. This patent concerns only routing said audio signals (not communication signals), and this simple routing is done without any data processing.

In U.S. Pat. No. 6,215,656 authors O'Neal; Sean P. at al propose a computer system comprising a circuit board on which an expansion board bay for receiving an expansion board is positioned and a connector module positionable independently of the expansion board. In this patent the term of “an expansion board bay” designates a socket and a unit of fastening for inserted expansion board. This patent describes the expansion board bay as positioned on the circuit board. In this case this bay can not be the mechanical (structural) part of computer housing.

The U.S. Pat. No. 6,134,612 offers an external flexible bay for personal computer which includes an external flexible bay adapted to receive either a modular battery pack or a modular disk drive to facilitate use such device with a portable personal computer. The subject of this patent is an external bay that relates to the personal computer and requires additional space (additional external device to personal computer).

### SUMMARY

The first aspect of the present invention consists in that the proposed motherboard expansion device inserted into one of conventional bays of non-portable computer chassis and said bay, for example, can be the bay for installing hard drive, CD or DVD drive, floppy drive etc. and connected to the motherboard via high speed interface.

The second aspect consists in that said motherboard expansion device allows to service a plurality of communication interfaces (lines) that are connected via cables to the expansion device with help of corresponding external connectors, placed on the motherboard expansion device. This allows to have almost unlimited number of external connectors for connection to the external peripheral devices in a system and at the same time placed those external connectors close to data processing unit.

The third aspect of the present invention consists in that said motherboard expansion device includes a data processing unit made in the form of one or more chips, and said unit may implement one or more functions chosen from the following group including: transmission/reception signals, analog/digital and digital/analog conversion, signal compression and decompression, spectral and cepstral transforming and data processing, communication protocol processing and data/protocol analyzing and etc.

The fourth aspect of the present invention consists in that said data processing unit implementation and the chosen set of said functions may be defined by concrete user requirements.

The fifth aspect consists in that said motherboard expansion device comprises a connector group for said high speed interface for connection to the motherboard and for power cable that connects said expansion device to the system power source.

The sixth aspect consists in necessity of placement of said external connectors for connection to communication interfaces (lines) in the immediate vicinity of said data processor circuits according to existing interface standards.

### BRIEF DESCRIPTION OF THE DRAWINGS

FIG. 1 shows a motherboard expansion device and a personal computer together.

FIG. 2 illustrates the disposition of the motherboard expansion device bay inside of the computer chassis and the main cable connections.

FIG. 3 shows an embodiment of PCB for the motherboard expansion device together with components disposed on this PCB.

FIG. 4 shows a single-board embodiment of the motherboard expansion device and two variants of an additional external panel.

### DETAILED DESCRIPTION OF THE PREFERRED EMBODIMENTS

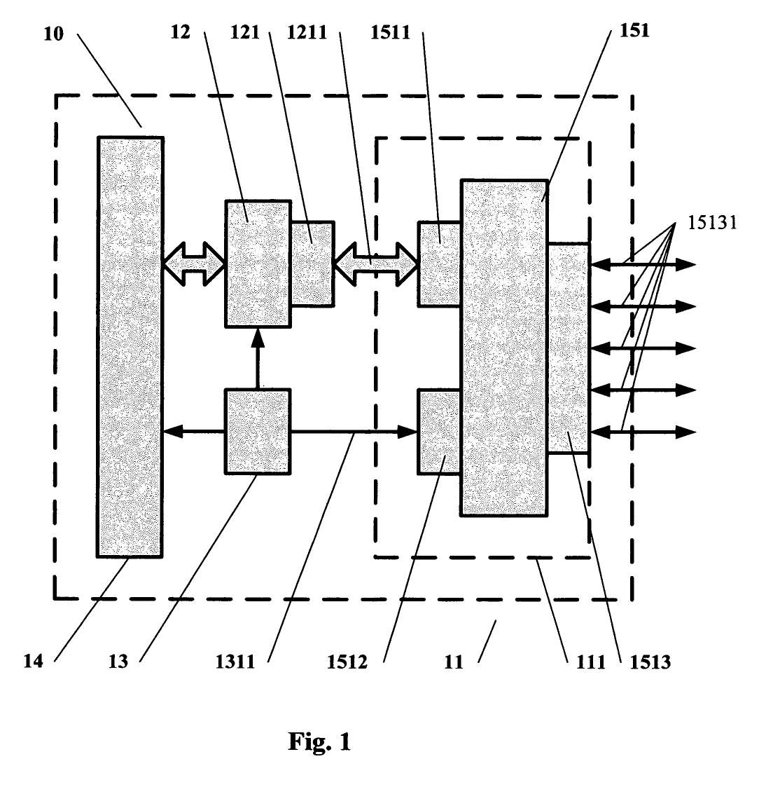

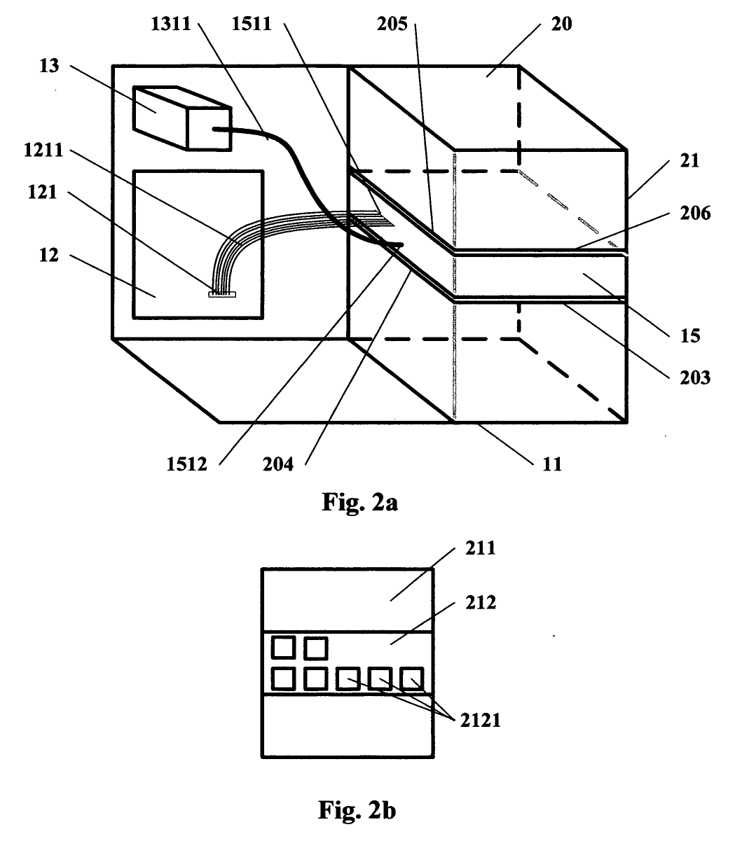

FIG. 1 and FIG. 2a show a motherboard expansion device 15 and a personal computer together. This non-portable computer 10 has a computer housing 11. Inside said computer housing a motherboard 12, a power source 13 and other computer blocks 14 are placed. Said computer housing 11 includes a structural (mechanical) bay 111 (FIG. 1). Said bay may be built as a conventional bay, used for inserting HD driver, CD driver etc, or as a special expansion bay. This bay includes a group of wall guides for received said motherboard expansion device. Such a bay may be used for placement of said motherboard expansion device 15 (FIG. 2a).

Inside said bay 111 a motherboard expansion device 15 is placed (it isn't marked in FIG. 1) comprising: a data processing unit 151 consisted of one or more chips and other components (capacitors, resistors etc), connectors 1511 (for high speed interface cable) and 1512 (power cable), and a connector block 1513. Said connectors 1511, 1512 and said connector block 1513 are connected to said data processing unit 151. Said data processing unit 151, said connectors 1511 and 1512 are placed for example on one or more printed circuit boards (PCBs), said connector block 1513 is placed on one or more printed circuit boards (PCBs) or on a special panel (it isn't shown).

Said motherboard 12 is connected to other computer blocks 14 and comprises a socket 121 placed on said motherboard. This socket 121 is connected to connectors 1511 of said data processing unit 15 via a high speed interface cable 1211. Said connectors 1511 may be connected to said motherboard 12 either directly via cable 1211 or through one or more adapters (it isn't shown). Said power source 13 is connected to the other computer blocks 14, to the motherboard 12, and to the connector 1512 of the data processing unit 151 via a power cable 1311 directly or via power adapters (it isn't shown).

Two groups of Audio interfaces are known. One is the simple analog audio interfaces that include only analog signal information (no control, status or acknowledge information) like audio output for Speakers or Headphone, audio input from microphones etc. Second group includes audio communication interfaces that include besides signal information (analog or digital) additional control information, status information and/or acknowledge information. The object of current invention is only second group of Audio interfaces.

Said connector block 1513 includes one or more connectors for connection to external devises via one or more communication interface cables 15131 correspondingly. These external communication (non-simple analog Audio, non-Video) interfaces may be chosen from the group including: DSNs family (DS1, DS2, DS3 etc), ENs family (E1,E2,E3 etc), J1, STS-Ns family (STS-1,STS-2 etc), OC-Ns family (OC-1,OC-2 etc), xDSL family, ISDN family, POTS (plain old telephone service) includes FXS (foreign exchange station) and FXO (foreign exchange office) interfaces, RS-Ns family (RS-232, RS-422, RS-423, RS-449, RS485 etc), V.35, HSSI, Gigabit Ethernet etc.

These and other similar interfaces don't define particular connector types and correspondingly the signal transmission media that depends on the interface and connector type. Therefore, the signal media types have to be defined. These media types are represented by a flat cable, a twisted pair (uncovered or in the view of a cable), a non-twisted pair (uncovered or in the view of a cable), a coaxial cable, a fiber optic cable.

FIG. 2a illustrates an exemplary embodiment of the present invention. The computer 10 includes said computer housing 11, the motherboard 12 and the power source 13 are fastened on said housing 11. One part 20 of said housing 11 includes a group of conventional bays for inserting a hard disk drive, a CD drive, a floppy-drive etc. Usually this part 20 is separated by mechanical (constructive) horizontal elements 203, 204, 205, 206 etc. and this separation defines the bays. The motherboard expansion device 15 may be inserted into one such bay. Another embodiment of said motherboard expansion device may be placed into special bay built-in other part of said computer housing 11 (it isn't shown). The part 20 is closed by the front panel 21 consisting of separate sections, corresponding to the said devices and other equipment placed in the part 20.

The motherboard expansion device 15 is connected to said motherboard 12 by a high speed interface cable 1211 that is connected a socket 121 mounted on said motherboard 12 and the connectors 1511 mounted on the motherboard expansion device 15. Said power source 13 connects by an electrical cable 1311 to the connector 1512 (FIG. 1) placed on the motherboard expansion device 15.

The bay shown in FIG. 2b and the one used for said motherboard expansion device 15 placement has shape and dimensions corresponding to existing standards. Said motherboard expansion device 15 is made so that its shape and dimensions allows it to be inserted in one of said bays. This bay is bounded from different sides by horizontal structural elements and by vertical structural elements. The bay front panel 212 is a part of a computer front panel 21 (FIG. 2b, front view) together with other parts 211 etc. A plurality of openings 2121 are intended for insertion of external communication cables 15131 (FIG. 1).

The motherboard expansion device 15 may be used in the form of separate package comprising one or more printed circuit boards (PCBs) that aren't shown in FIG. 2a or this package may be placed inside separate metal or plastic casing (it isn't shown).

Said cable 1211 is the high-speed interface cable. Said high-speed interface can be chosen from the group, including: PCI, PCI-X, PCI-express, Gigabit Ethernet, Rapid I/O etc. Said cable 1211 may be connected to said motherboard directly or via an adapter card (it is not shown).

One of said PCBs may comprise additional interface and power connectors (they aren't shown) allowing to connect at least one additional motherboard expansion device. The additional power connector may be mounted on said PCB or on said power source 13.

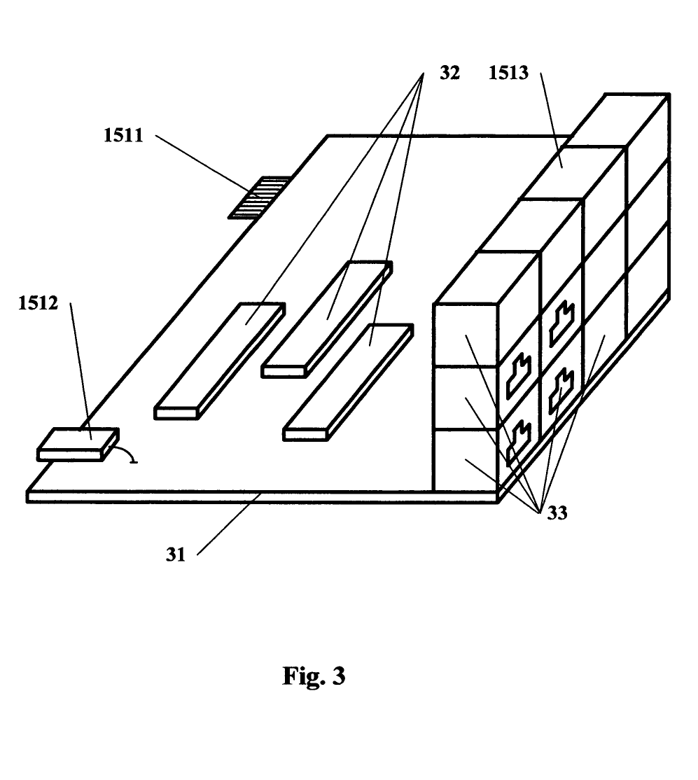

FIG. 3 shows said PCB 31. The data processing unit 151 including chips 32. Said connector block 1513 disposed on said PCB 31. This connector block 1513 mounted on said PCB 31. In FIG. 3 said connector block 1513 may include a plurality of connectors 33, for example, RJ-45, RJ-11, RJ-14, RJ-21x, SCSI, coax connectors, fiber optic connectors and etc.

The data processing unit 151 (FIG. 1) may include a multichannel adapter for communicating signals of a plurality of connectors 33, and said data processing unit 151 is represented by chips 32 (FIG. 3). The plurality of said connectors, matching resistors, capacitors and correspondingly a plurality of necessary contact points on said printed board and a plurality of communication lines (wired or printed) on said PCB (they aren't shown) require critical placement of said components even with the use of low speed interfaces.

Said connector block 1513 may comprise various connectors 33 that correspond to various external communication interfaces.

The types of said connectors 33 that are composed said connector block 1513 are in compliance with requirements that are set by standards imposed on said external communication interfaces.

Each of said one or more chips 32 that are constituents of said data processing unit 151 comprises corresponding quantity of external pins (they aren't shown) that are connected to an electric circuit of said motherboard expansion device 15. This electric circuit connects said connectors 33 of said connector block 1513, said connectors 1511 of said high speed connector group, said connector 1512 and said data processing unit 151.

Said chips 32 together with their pins and said connectors 33 of said connector block 1513 are mounted in the vicinity of each other so that the parameters (length, form, impedance) of traces between corresponding pins and corresponding connectors are in compliance with said used interface standards or requirements of the design.

Using high speed interfaces, for example, Gigabit Internet dictate the serious requirement concerning length, form, impedance of communication lines (printed or wired) between said data processing unit and corresponding external connectors.

In the case when the number of external connectors exceeds the maximum number of external connectors that can be placed on said motherboard expansion device, it is possible to move part of said connectors and if necessary part of the chips to an additional external panel.

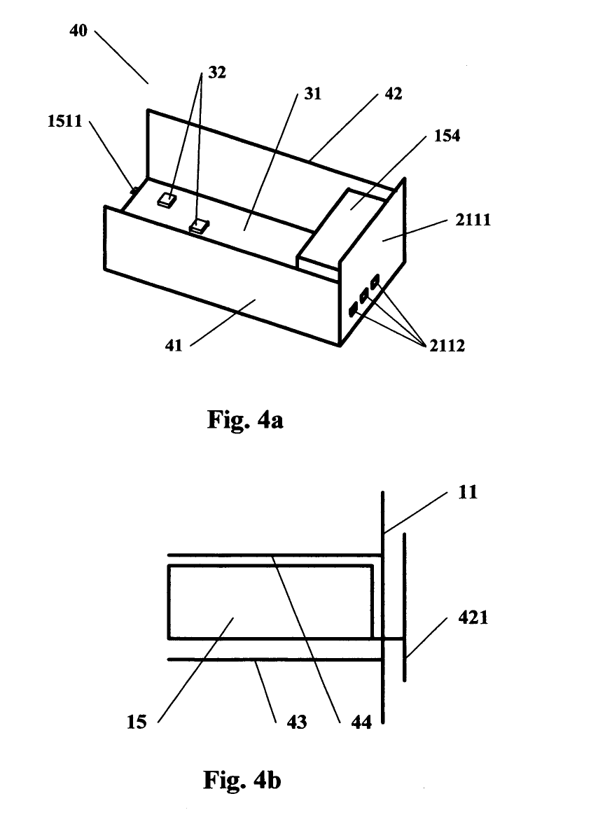

FIG. 4a illustrates a sketch of an exemplary embodiment of said motherboard expansion device 40 consisting of one PCB 31 (FIG. 3). This embodiment comprises a front panel 2111 (FIG. 2b) that is fastened to said PCB 31 and two lateral walls 41 and 42 that are fastened to said PCB 31. In FIG. 4a it is shown said connector block 154 and a plurality of openings 2112 for said communication interfaces. Said lateral walls are useful for inserting said motherboard expansion device into corresponding bay as guides and include means for fixing said device inside said bay. It is shown said chips 32 and said high-speed interface connectors 1511.

In the case when said motherboard expansion device needs cooling then openings can be placed in the front panel for enabling air flow (not shown).

FIG. 4b illustrates another embodiment of said motherboard expansion device 15 that is placed inside said bay bounded by top and bottom bay walls 43, 44 of said computer housing 11 and said front panel 421. Said front panel 421 or its part may be placed at some distance (up to 10.0 cm approximately) from said computer housing surface. This distance is useful for cooling said motherboard expansion device by creating openings for air flow and allows placing necessary components and fans.

Said front panel can be expended by external panel (not shown) in the different directions for placement at least a part of said connectors if said connector block isn't totally positioned on said PCBs.

We claim:

1. A motherboard expansion device for use in non-portable computer, wherein said computer comprises a computer housing, a motherboard, a power source, and at least one bay that is built-in inside said computer housing, is its mechanical (structural) part of said computer housing and includes a group of wall guides for receiving said device;
said motherboard expansion device comprising:
one or more printed circuit boards (PCBs) connected together and placed inside said computer into one of said bays,
a data processing unit placed on said PCBs,
a high speed interface connector group mounted on said PCBs, connecting said data processing unit and a corresponding socket placed on said motherboard via cable directly or through one or more adapters,
a connector block, including one or more communication connectors that are connected to said data processing unit, and said connectors are intended for connection to external devices via one or more external cables;
said communication connectors are intended to provide connection to external devices via at least one non-simple analog Audio, non-Video, non-USB and non-IEEE 1394 communication interface;
said motherboard expansion device comprising further:
only non-mechanical non-rotating memory components.

2. The motherboard expansion device according to claim 1, wherein said device includes an additional power connector mounted on one of said PCBs for connection via an additional cable to said power source.

3. The motherboard expansion device according to claim 1, wherein said bay is conventional bay or an expansion bay, and said conventional bay is a hard drive bay or a CD/DVD ROM drive bay or a floppy disk drive bay.

4. The motherboard expansion device in according to claim 1 wherein one or more said PCBs on which said data processing unit and high speed interface connector group are placed, and said connector block including one or more communication connectors, and said motherboard expansion device may be made in one of two forms:
1) in the form of a package consisting of said one only PCB or more than one said PCBs fastened together, said package comprises a front panel fastened to one or more said PCBs and has the shape and dimension to be plugged-in said computer bay that is built-in inside said computer housing and fitted with said guides,
2) in the form wherein said motherboard expansion device comprises a case, said case comprises a front panel, other walls and one or more said PCBs placed inside said case, and wherein said one or more PCBs characterized in that their shape and dimension allow said PCBs to be plugged into said case, and further said case has the shape and dimension to be plugged into said bay that is built-in inside said computer housing and is fitted with said guides.

5. The motherboard expansion device according to claim 4, wherein said front panel includes one or more through openings.

6. The motherboard expansion device according to claim 4, comprising an external panel that is an expansion of said front panel.

7. The motherboard expansion device according to claim 4, comprising said front panel and at least a part of said front panel is placed at a distance up to 10 cm approximately from computer housing.

8. The motherboard expansion device according to claim 6, wherein at least a part of said connector block is positioned on said one or more PCBs, and in the case when said connector block isn't totally positioned on said PCBs then a part of said connectors may be mounted on said additional part of said external panel.

9. The motherboard expansion device according to claim 1, wherein said communication connectors are intended to provide connection to external devices via at least one non-Audio, non-Video, non-USB, non-10/100 Mbit Ethernet and non IEEE 1394 communication interface;

10. The motherboard expansion device according to claim 1, comprising additional connector group that allows to connect through additional cable to at least one additional motherboard expansion device.

11. The motherboard expansion device according to claim 1, wherein data processing unit may implement one or more functions chosen from the following group including:
data processing and analyzing,
transmission/reception signals,
analog/digital and digital/analog conversion,
signal compression and decompression,
spectral and cepstral transforming and processing,
communication protocol/interface implementation,
communication protocol/interface analyzing.

12. The motherboard expansion device according to claim 1, wherein said connector block comprises connectors, the types of which are in compliance with requirements that are set by standards imposed on said external communication interfaces;
said device wherein one or more chips that are constituents of said data processing unit and said connectors of said connector block are mounted in the immediate vicinity from each other so that the parameters (length, form, impedance) of traces between said chips and said connectors are in compliance with said standards.

13. The motherboard expansion device according to claim 1, wherein said external communication interfaces and said connector block are chosen for supporting connection said motherboard expansion device to the external devices via one or more flat cables, twisted pairs, non-twisted pairs, coaxial cables, fiber optic cables.
